(19) United States
(12) Patent Application Publication
(10) Pub. No.: US 2013/0173788 A1
(43) Pub. Date: Jul. 4, 2013

(54) NETWORK ACCESS APPARATUS

(71) Applicant: Hangzhou H3C Technologies Co., Ltd., Zhejiang (CN)

(72) Inventor: Xiaoheng Song, Beijing (CN)

(73) Assignee: HANGZHOU H3C TECHNOLOGIES CO., LTD., Zhejiang (CN)

(21) Appl. No.: 13/728,593

(22) Filed: Dec. 27, 2012

(30) Foreign Application Priority Data
Dec. 31, 2011 (CN) 201110458173.4

(51) Int. Cl. H04L 12/56

(52) U.S. Cl. CPC H04L 45/02
USPC 709/224

(57) ABSTRACT

A network access apparatus comprising a tunneling interface to collect device access information of network devices of a first computer network having a first network gateway device and device access information of network devices of a second computer network having a second network gateway device, wherein the apparatus is to send device access information of network devices of said first computer network to said second computer network upon receipt of an inquiry for request of device access information from said second computer network, and vice versa.

### CLAIM FOR PRIORITY

The present application claims priority under 35 U.S.C 119 (a)-(d) to Chinese Patent application number 201110458173.4, filed on Dec. 31, 2011, which is incorporated by reference in its entirety.

### BACKGROUND

Computer service users and computer resources are increasingly contained in geographically dispersed networks for delivery as a service to users over public networks such as the Internet. As such resources, for example, applications, storage and other IT (information technology) infrastructure are distributed in geographically dispersed locations, interconnection between such resources is important to make them work like a unified enterprise such that the resources can be delivered over public networks to end users easily, quickly, securely and reliably.

A Virtual Private Network (VPN) is an example of network technologies that create a secure network connection over a public network such as the Internet. The VPN uses different types of VPN protocols to secure the transport of data traffic over a public network infrastructure. IP (Internet Protocol) in IP/GRE (Generic Route Encapsulation) and MPLS (Multiple Label Switching) are examples of such VPN protocols.

Cloud computing is another example of such network technologies. In a cloud computing environment, users usually entrust remote services with their data, software and computation.

### DESCRIPTION OF FIGURES

The disclosure will be described by way of non-limiting examples with reference to the accompanying Figures, in which:—

FIG. 1 is a schematic diagram depicting an example of a first network and a second network connected across a public network,

FIG. 2 is a schematic diagram depicting the example networks of FIG. 1 with an example intermediate edge apparatus,

FIG. 2A depicts the example network of FIG. 2 in an initialization process,

FIG. 2B depicts the example network of FIG. 2 in an example operation when an edge device request device access information from a dedicated edge device,

FIG. 2C depicts the example network of FIG. 2B in an example operation when the dedicated edge device sends the requested network access information to the requesting edge device,

FIG. 2D is a flow diagram showing an example operation flow of the dedicated edge device of FIG. 2,

FIG. 2E is a flow diagram showing an example operation flow of an edge device, and

FIG. 2F is a flow diagram showing an example operation flow of an edge device; and

FIG. 3 is a schematic diagram depicting another example network.

### DESCRIPTION OF EXAMPLES

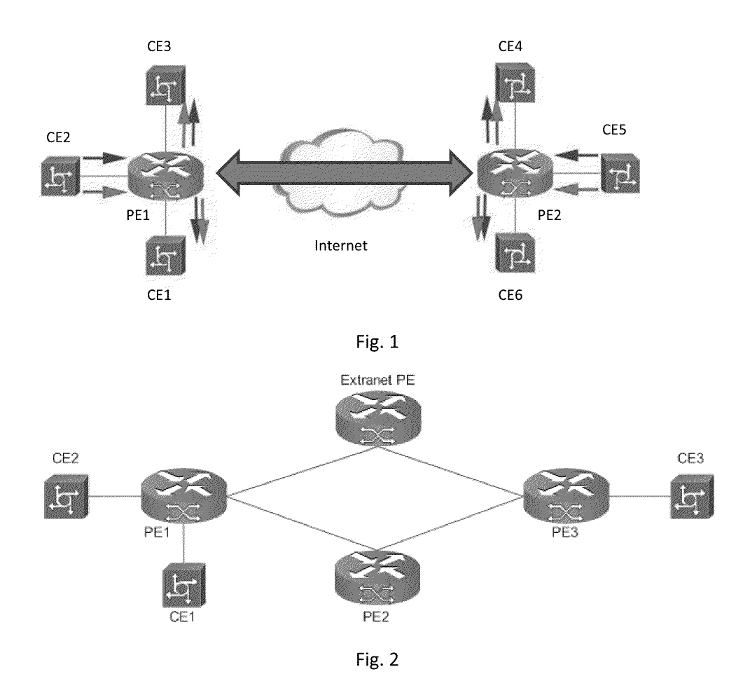

FIG. 1 depicts a first computer network (‘first network’) and a second computer network (‘second network’) connected across a public network such as the Internet. The first network comprises a plurality of network devices CE1, CE2, CE3 and an edge device such as a router PE1. The network devices CE1, CE2, and CE3 can communicate with each other via the router PE1. Each one of the network devices CE1, CE2, and CE3 can communicate with the outside world via the router PE1 and the Internet. The router PE1 contains a storage device on which a routing and forwarding table containing the device access information of each of the network devices, namely, CE1, CE2, and CE3, within the first network is stored. The device access information includes a unique device identifier of each of the network devices. The physical address, for example the MAC (Medium Access Control) address, and the IP address of a network device are examples of suitable unique device identifiers. In this example, the routing and forwarding table of PE1 includes an ARP (Address Resolution Protocol) table comprising a listing of IP addresses and MAC addresses of all the network devices CE1, CE2, CE3 as well as their respective mapping or correlation. The Router also includes a tunneling interface, such as a tunneling port, for forwarding encapsulated traffic to appropriate tunnel ingresses and an Internet interface for forward Internet designated traffic. The routers PE1, PE2 are edge devices which are managed and controlled by a service provider which provides network services for public access. Such routers are referred to as provider edge (PE) devices in VPN terminology.

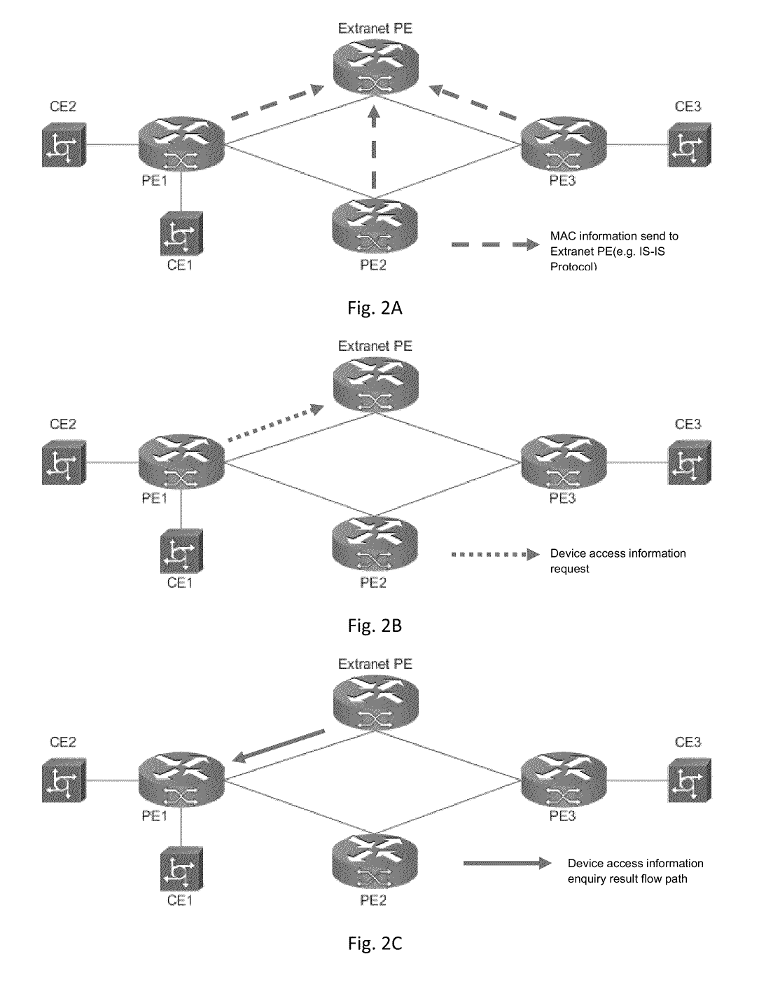

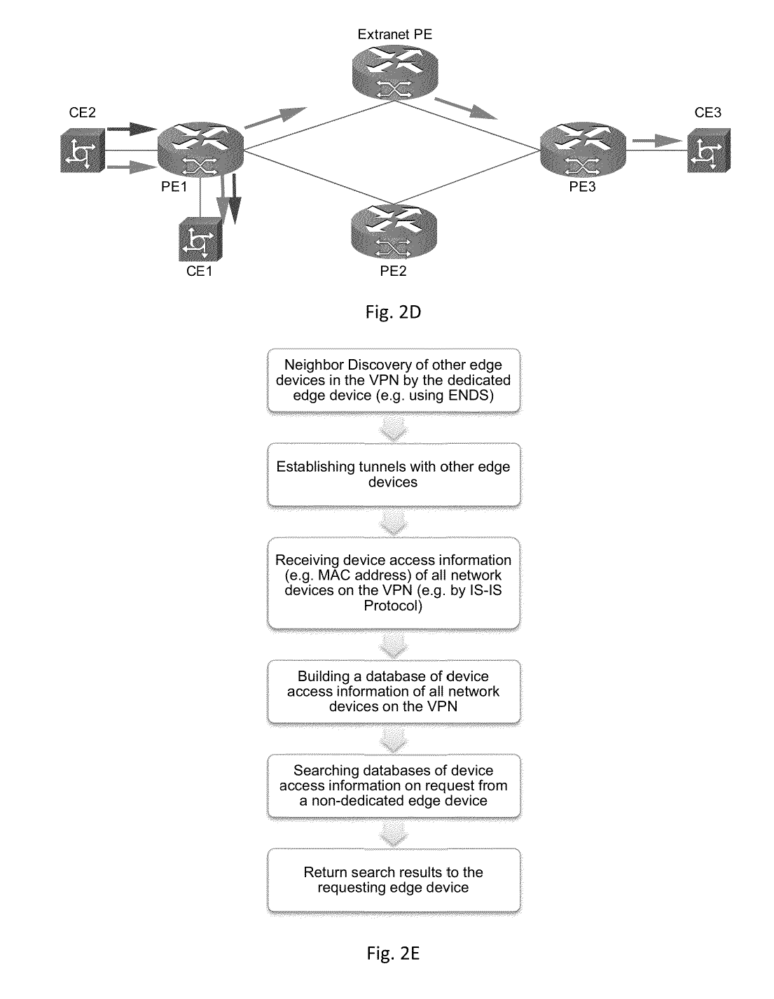

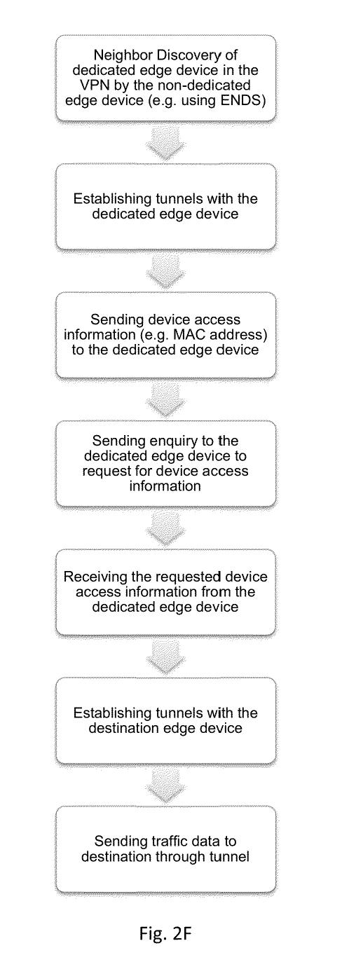

The second network depicted in FIGS. 2, and 2A to 2C comprises a plurality of network devices CE4, CE5, and CE6 and an edge device such as a router PE2. The network devices CE4, CE5, and CE6 can communicate with each other via the router PE2. Each one of the network devices CE4, CE5, CE6 can communicate with the outside world via the router PE2 and the Internet. A routing and forwarding table containing the device access information of the network devices, namely, CE4, CE5, and CE6, is stored the router PE2. While the first and the second networks are geographically dispersed across a public network, the network devices CE1, CE2, CE3, CE4, CE5, and CE6 edge devices which are controlled and managed as network devices of the same private network. Therefore, the first and the second networks collectively form an example virtual private network (VPN), and the first and the second networks are sub-networks or branch networks of the VPN. An edge device may be a router, a switch, a VPN server or a VPN switch. RFC 2547 and RFC 4026 are incorporated herein by reference.

As data traffic between the first network and the second network is transported over a public network, the data traffic will usually be encapsulated or encrypted using a tunneling protocol. While there are many tunneling protocols, GRE (Generic Routing Encapsulation) is used as a convenient example herein because this is a protocol widely used to transport data packets over IP. MPLS (Multiprotocol Label Switching) and IPSec are other tunneling protocols which are suitable for transport of data traffic over IP.

When a network device, say CE1, of the first network sends a traffic comprising data packets designated to another network device CE2 on the same network, the network device CE2 will send the traffic to the router PE1 for forwarding. The router PE1 upon receipt of the data packet will look up the routing and forwarding table and then forward the traffic to CE2 according to the unique device identifier carried in the data packet.

When the network device CE1 sends traffic to the Internet, the router PE1 upon receipt of the traffic will route the traffic of IP packets to its Internet port and then forward the traffic to the Internet and establish data communication with a destination network or device.

When the network device CE1 sends a traffic comprising data packets designated to another network device CE4 (the ‘destination network device’) on the other network, which is part of the VPN, the router PE1 would not be able to find the unique device identifier of CE4 on the routing and forwarding table. On the other hand, the Router PE1 (or more exactly the processor of the Router PE1) would be able to identify from the destination address of the destination network device, for example the IP header of the destination IP address, that the destination network device is on the same VPN. As a result, the Router PE1 will forward the traffic to the tunneling interface for forwarding to other sub-networks of the VPN after GRE encapsulation of the data packets as depicted in FIG. 2D. RFC 1702 as a specific implementation of GRE encapsulation of IP packets over IP and RFC 1597 defining IP address ranges reserved for private IP networks are incorporated herein by reference.

Before the Router PE1 will forward the tunnel heading traffic to the tunneling interface, the Router PE1 will communicate with another edge device, which is a designated edge device identified as Extranet PE in FIG. 2, to obtain the device access information of the network device CE4, as depicted in the example flow diagram of FIG. 2F. The Extranet PE is a part of the VPN and is communicable with PE1 and PE2 via the public network. The Extranet PE comprises a processor and a storage device to compile and store a routing and forwarding table. This routing and forwarding table comprises a listing of device access information of all the network devices on the VPN. Specifically, the unique device identifiers in this example include MAC addresses, and the routing and forwarding table of the Extranet PE comprises an ARP table which includes a listing of IP addresses and MAC addresses of all the network devices on the VPN as well as their respective mapping and/or correlation. Since the Extranet PE is to communicate with other VPN edge devices or VPN subnets through the public network, the Extranet PE comprises a tunneling interface to facilitate such communication. The ARP table is an example of a routing and forwarding table.

Upon receipt of a device access inquiry from an edge device such as PE1 or PE2 to request for device access information as depicted in FIG. 2B, the Extranet PE will reply with data packets comprising the appropriate device access information to the requesting edge device PE1 or PE2 as depicted in FIG. 2C. The edge device upon receipt of the device access information will encapsulate the device access information in the traffic for forwarding to the appropriate tunnel via the tunneling interface. The device access information in this example will include the corresponding IP and MAC addresses of the designated network device which is the subject of inquiry.

The Extranet PE will need to collect and store the device access information of all the network devices in order to have them available for use by other edge or gateway devices of the VPN. Initially, the Extranet PE will identity all branch networks (also known as subnets') of the VPN by going through a neighbor discovery process as depicted in FIGS. 2A and 2E. The discovery process can be by means of VPLS-based VPN auto-discovery, IPv6 neighbor discovery, ISIS discovery, or EVI neighbor discovery (END) for Ethernet Virtualization Interconnect (EVI). After completion of the neighbor discovery process, all the edge and gateway devices of the VPN will be identified or discovered by the Extranet PE. The Extranet PE will then learn the device access information of all the network devices of the VPN and then stored all the device access information on the routing and forwarding table. The learning process can be performed by using the same protocol for neighbor discovery, such as IS-IS (Intermediate System to Intermediate System) or END.

As all the device access information of all the network devices of the entire VPN is now kept on a designated edge device, which is the Extranet PE in the present example, there is no need to use a flooding protocol to discover the VPN subnets or the edge devices of the subnets.

In one example, two dedicated tunnels, namely, an ordinary IP GRE tunnel and an extended IP GRE tunnel, are maintained on the Extranet PE. The ordinary IP GRE tunnel is allocated for data traffic of unicast or multicast packets having known device identifier of the destination device, and this type of traffic will be forwarded to the known destination. The extended IP GRE tunnel is allocated for data traffic of unicast or multicast packets having unknown device identifier, and this type of traffic will be returned to the source edge device with the encapsulated device access information requested.

With such a dedicated edge device to hold the device access information of all network devices on the VPN, the use of flooding protocols for discovery can be alleviated. At the same time, the problem of conflicting device identifier information such as conflicting MAC addresses and Hash conflicts occurred during use of flooding protocols for neighbor discovery can also be alleviated.

While two VPN subnets are depicted in the example of FIG. 1, it would be appreciated by persons skilled in the art that a real VPN may comprise many subnets. For example, each of the network devices CE1, CE2, CE3, may be a customer device or customer edge device. Where the edge device is a customer edge (CE) device, the CE is in itself a gateway device of a subnet connected to a provider edge (PE) device.

As an example, the designated apparatus Extranet PE can be a dedicated network access apparatus provided for VPN management or as a VPN PE (provider edge) device configured to operate as an ordinary PE as well as the designated apparatus.

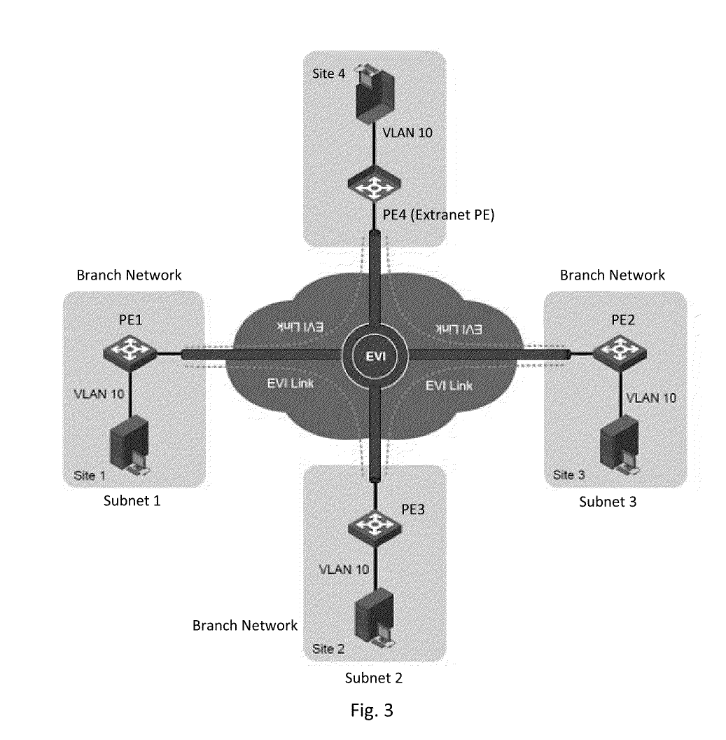

FIG. 3 depicts a plurality of geographically dispersed branch networks, Subnet 1, Subnet 2, Subnet 3, and Subnet 4. Each of the branch networks is connected to a PE device and the branch networks collectively operate as an EVI to illustrate an example of cloud computing application of this disclosure. EVI is a layer 2 VPN interconnection technology using ‘MAC in IP’ encapsulation and data communication between the branch networks is by means of EVI Links. Each branch network of the EVI comprises PE and the PE of Subnet 4 also operates as an Extranet PE.

There is disclosed a network access apparatus comprising a tunneling interface to collect device access information of network devices of a first computer network having a first network gateway device and device access information of network devices of a second computer network having a second network gateway device, wherein the apparatus is to send device access information of network devices of said first computer network to said second computer network upon receipt of an inquiry for request of device access information from said second computer network, and vice versa. The Extranet PE is an example of such a network access apparatus. The provision of a designated network access apparatus mitigates the need of using a flooding protocol, which is non-bandwidth friendly to manage a VPN.

There is also disclosed a network gateway device for facilitating network devices of a first computer network to communicate with each other and to communicate with devices of a second and other computer networks, wherein the apparatus is to look for locally stored network device access information upon receipt of data which are destined to a destination network device in order to forward the received data to the destination network device; and wherein the apparatus comprises a tunneling interface which is to send an inquiry to a designated network access apparatus which is outside of the first computer network when the device access information of the destination network device is not found locally in the first computer network. The edge devices such as PE1 and PE2 are examples of such a network gateway device.

In addition, there is disclosed computer network system comprising a first computer network having a first network gateway device, a second computer network having a second network gateway device, and a network access apparatus. The first computer network, the second computer network and the network access apparatus are to communicate via a public network such as the internet using a tunneling protocol. The network access apparatus comprises a tunneling interface to collect device access information of network devices of said first computer network and device access information of said second computer network, and wherein the network apparatus is to send device access information of network devices of said first computer network to said second computer network upon receipt of device access information inquiry from said second computer network, and vice versa. Such an example of network system demonstrations an example application of the network access apparatus of the present disclosure in cloud computing environment utilizing layer 2 VPN interconnect of the advantageous EVI technology.

The above examples can be implemented by hardware, software or firmware or a combination thereof. For example the various methods, processes and functional units described herein may be implemented by a processor (the term processor is to be interpreted broadly to include a CPU, processing unit, ASIC, logic unit, or programmable gate array etc.). The processes, methods and functional units may all be performed by a single processor or split between several processers; reference in this disclosure or the claims to a ‘processor’ should thus be interpreted to mean ‘one or more processors’. The processes, methods and functional modules can be implemented as machine readable instructions executable by one or more processors, hardware logic circuitry of the one or more processors or a combination thereof. Further the teachings herein may be implemented in the form of a software product. The computer software product is stored in a storage medium and comprises a plurality of instructions for making a computer device (which can be a personal computer, a server or a network device such as a router, switch, access point etc.) implement the method recited in the examples of the present disclosure.

1. A network access apparatus comprising a tunneling interface to collect device access information of network devices of a first computer network having a first network gateway device and device access information of network devices of a second computer network having a second network gateway device, wherein the apparatus is to send device access information of network devices of said first computer network to said second computer network upon receipt of an inquiry for request of device access information from said second computer network, and vice versa.

2. A network access apparatus according to claim 1, wherein the first and the second networks are private networks, and the network access apparatus is to communicate with the first and the second computer networks via a public network using a tunneling protocol such as IP GRE protocol.

3. A network access apparatus according to claim 1, wherein the tunneling interface is IP GRE compatible.

4. A network access apparatus according to claim 1, wherein the apparatus is to collect said device access information by ISIS protocol.

5. A network access apparatus according to claim 1, wherein the device access information is in MAC (medium access code) form and the network access apparatus is to collect the device access information in MAC-over-GRE-over-IP protocol.

6. A network access apparatus according to claim 1, wherein the apparatus is to collect the inquiry on said device access information which is designated to said apparatus.

7. A network access apparatus according to claim 1, wherein the apparatus is an edge device of a third network which is to communicate with the first and second network via a public network such as the Internet.

8. A network access apparatus according to claim 6, wherein the apparatus is to communicate with the first network gateway device and the second network gateway device using IP GRE tunnels to collect said device access information of said first and said second computer networks.

9. A network access apparatus according to claim 1, wherein the apparatus is to collect and store MAC information of all network devices connected by Ethernet Virtual Interconnect (EVI).

10. A network gateway device for facilitating network devices of a first computer network to communicate with each other and to communicate with devices of a second and other computer networks, wherein the network gateway device is to look for locally stored network device access information upon receipt of data which are destined to a destination network device in order to forward the received data to the destination network device; and wherein the network gateway device comprises a tunneling interface which is to send an inquiry to a designated network access apparatus which is outside of the first computer network when the device access information of the destination network device is not found locally in the first computer network.

11. A network gateway device according to claim 10, wherein the first, the second and the other computer networks are private computer networks, and the network gateway device is to communicate with the designated network access apparatus via a public network using a tunneling protocol such as IP GRE protocol.

12. A network gateway device according to claim 11, wherein the tunneling interface is IP GRE compatible.

13. A network gateway device according to claim 10, wherein the device is to send said device access information by ISIS protocol.

14. A network gateway device according to claim 10, wherein the device is to send said device access information with no flooding.

15. A network gateway device according to claim 10, wherein the device access information is in MAC (medium access code) and the network gateway device is to send said device access information in MAC-over-GRE-over-IP protocol.

16. A network gateway device according to claim 10, wherein the device is to support inter-network data communication using encapsulated traffic, such as tunneling traffic by means of encapsulated internet protocol (IP) packets over IP.

17. A computer network system comprising a first computer network having a first network gateway device, a second computer network having a second network gateway device, and a network access apparatus; wherein the first computer network, the second computer network and the network access apparatus are to communicate via a public network such as the internet using a tunneling protocol; and wherein the network access apparatus comprises a tunneling interface to collect device access information of network devices of said first computer network and device access information of said second computer network, and wherein the network apparatus is to send device access information of network devices of said first computer network to said second computer network upon receipt of device access information inquiry from said second computer network, and vice versa.

18. A computer network system according to claim 17, wherein the first gateway device, the second gateway devices and the network access apparatus are edge devices of a Virtual Private Network.

19. A computer network system according to claim 18, wherein data traffic between the first network gateway device and the second network gateway device I sby a dedicated tunnel of MAC on IP.

20. A computer network system according to claim 19, wherein the apparatus is to collect and store a listing of IP addresses and MAC addresses of all the network devices on the VPN as well as their respective mapping or correlation.
